(19) United States
(12) Patent Application Publication
(10) Pub. No.: US 2019/0301453 A1
(43) Pub. Date: Oct. 3, 2019

(54) INTEGRATED MOTOR AND PUMP INCLUDING INLET AND OUTLET FLUID CONTROL SECTIONS

(71) Applicant: Schaeffler Technologies AG & Co. KG, Herzogenaurach (DE)

(72) Inventors: Jeffrey Hemphill, Copley, OH (US); George Philip, Wooster, OH (US)

(21) Appl. No.: 15/940,567

(22) Filed: Mar. 29, 2018

(51) Int. Cl. F04C 15/00; F04C 2/10

(52) U.S. Cl. CPC F04C 15/008; F16H 61/0031; F04C 2/105

(57) ABSTRACT

A pump includes a fluid inlet section; a fluid outlet section; a stator axially between the fluid inlet section and the fluid outlet section; a rotor axially between the fluid inlet section and the fluid outlet section, the rotor and the stator defining a fluid flow chamber radially therebetween, the rotor being rotatable inside of the stator by electromagnetic forces urging the rotor towards the stator; an inlet control section configured for regulating fluid flow from the fluid inlet section into the fluid flow chamber; and an outlet control section configured for regulating fluid flow from the fluid flow chamber into the fluid outlet section. The rotor, the stator, the inlet control section and the outlet control section are arranged and configured such that rotation of the rotor in the stator generates in the fluid flow chamber a first pressure portion and a second pressure portion that rotate about a center axis of the rotor. The first pressure portion has a lower pressure than the second pressure portion. The inlet control section is configured such that fluid from the fluid inlet section is forced through the inlet control section to the first pressure portion as the first pressure portion rotates about the center axis of the rotor. The outlet control section is configured such that fluid from the fluid flow chamber is forced through the outlet control section from the second pressure portion to the fluid outlet section as the second pressure portion rotates about the center axis of the rotor.

The present disclosure relates generally to pumps and more specifically to pumps of automotive vehicle transmissions.

### BACKGROUND

In an automatic transmission vehicle, electrically driven auxiliary pumps may be used. These pumps may be integrated into a transmission internally or externally depending on axial constraints and system requirements

### SUMMARY OF THE INVENTION

A pump is provided. The pump includes a fluid inlet section; a fluid outlet section; a stator axially between the fluid inlet section and the fluid outlet section; a rotor axially between the fluid inlet section and the fluid outlet section, the rotor and the stator defining a fluid flow chamber radially therebetween, the rotor being rotatable inside of the stator by electromagnetic forces urging the rotor towards the stator; an inlet control section configured for regulating fluid flow from the fluid inlet section into the fluid flow chamber; and an outlet control section configured for regulating fluid flow from the fluid flow chamber into the fluid outlet section. The rotor, the stator, the inlet control section and the outlet control section are arranged and configured such that rotation of the rotor in the stator generates in the fluid flow chamber a first pressure portion and a second pressure portion that rotate about a center axis of the rotor. The first pressure portion has a lower pressure than the second pressure portion. The inlet control section is configured such that fluid from the fluid inlet section is forced through the inlet control section to the first pressure portion as the first pressure portion rotates about the center axis of the rotor. The outlet control section is configured such that fluid from the fluid flow chamber is forced through the outlet control section from the second pressure portion to the fluid outlet section as the second pressure portion rotates about the center axis of the rotor.

According to embodiments of the pump, the inlet control section may include a plurality of circumferentially spaced inlet control valves and the outlet control section includes a plurality of circumferentially spaced outlet control valves. The rotor and stator may be configured such that each of the first pressure portion and the second pressure portion passes by each of the inlet control valves and each of the outlet control valves multiple times during a single rotation of the rotor about the center axis of the rotor. The inlet control valves may be configured such that as the first pressure portion passes each of the inlet control valves, the respective inlet control valve being passed by the first pressure portion opens. The inlet control valves may be configured such that as the second pressure portion passes each of the inlet control valves, the respective inlet control valve being passed by the second pressure portion closes. The outlet control valves may be configured such that as the second pressure portion passes each of the outlet control valves, the respective outlet control valve being passed by the second pressure portion opens. The outlet control valves may be configured such that as the first pressure portion passes each of the outlet control valves, the respective outlet control valve being passed by the first pressure portion closes. Each of the inlet control valves and each of the outlet control valves may be check valve including a seat, a closing member and a spring. The inlet control section and the outlet control section may be rotationally fixed so as not to rotate as the rotor rotates. The rotor and the stator may be arranged and configured such that the rotor moves eccentrically within the stator. The stator may include at least four electrical windings configured for receiving current to generate the electromagnetic forces for urging the rotor towards the stator to rotate the rotor.

An automotive vehicle transmission comprising the pump may also be provided.

A method of constructing a pump is also provided. The method includes providing a rotor radially inside of a stator; fixing an inlet control section with respect to the stator at a first axial side of the rotor; fixing an outlet control section with respect to the stator at a second axial side of the rotor; providing a fluid inlet section upstream of the inlet control section; and providing a fluid outlet section downstream of the outlet control section, the rotor and the stator defining a fluid flow chamber radially therebetween. The rotor, the stator, the inlet control section and the outlet control section are arranged and configured such that rotation of the rotor in the stator generates in the fluid flow chamber a first pressure portion and a second pressure portion that rotate about a center axis of the rotor. The first pressure portion has a lower pressure than the second pressure portion. The inlet control section is configured such that fluid from the fluid inlet section is forced through the inlet control section to the first pressure portion as the first pressure portion rotates about the center axis of the rotor. The outlet control section is configured such that fluid from the fluid flow chamber is forced through the outlet control section from the second pressure portion to the fluid outlet section as the second pressure portion rotates about the center axis of the rotor.

According to embodiments of the method, the inlet control section may include a plurality of circumferentially spaced inlet control valves and the outlet control section includes a plurality of circumferentially spaced outlet control valves. The rotor and stator may be configured such that each of the first pressure portion and the second pressure portion passes by each of the inlet control valves and each of the outlet control valves multiple times during a single rotation of the rotor about the center axis of the rotor. The inlet control valves may be configured such that as the first pressure portion passes each of the inlet control valves, the respective inlet control valve being passed by the first pressure portion opens. The inlet control valves may be configured such that as the second pressure portion passes each of the inlet control valves, the respective inlet control valve being passed by the second pressure portion closes. The outlet control valves may be configured such that as the second pressure portion passes each of the outlet control valves, the respective outlet control valve being passed by the second pressure portion opens. The outlet control valves may be configured such that as the first pressure portion passes each of the outlet control valves, the respective outlet control valve being passed by the first pressure portion closes. The inlet control section may be inserted into a section of the fluid inlet section and the outlet control section may be inserted into a section of the fluid outer section. The stator may include a plurality of windings and a plurality of legs, each of the windings being wrapped around one of the legs. At least one of the fluid inlet section and the fluid outlet section may including a plurality of axially extending fingers. The axially extending fingers may be slid in between the legs radially inside of the winding. The rotor may be positioned radially inside of the axially extending fingers.

### BRIEF DESCRIPTION OF THE DRAWINGS

The present disclosure is described below by reference to the following drawings, in which:

FIG. 1 schematically shows a cross-sectional side view of a pump for an automotive vehicle transmission according to an embodiment of the present disclosure;

FIG. 2 shows an axial cross-sectional view along A-A in FIG. 1; and

FIG. 3 shows an axial cross-sectional view along B-B in FIG. 1.

### DETAILED DESCRIPTION

The disclosure provides a space-saving electrically driven auxiliary pump including a rotor and stator of a motor that are dual purposed as the rotor and stator of the pump. The rotor and stator formed a fluid chamber radially therebetween for fluid to flow axially through. The rotor is positioned inside the stator using a gerotor pump, for example, or internal gear pump, vane pump, or several other pump types. An electric current is sent through at least four stator windings to create a magnetic field pulling the rotor towards that coil in order to complete a magnetic circuit formed by the legs of the stator. Movement of the rotor towards the coil displaces fluid thus creating pressure, and a vacuum is created on the other side of the rotor. As the rotor travels toward the first coil, the next coil is energized to roll the rotor around the inside of the stator pumping fluid from inlet to outlet. Check valves can be provided at the inlet and outlet of fluid chamber to regulate the flow of fluid in and out of the fluid chamber.

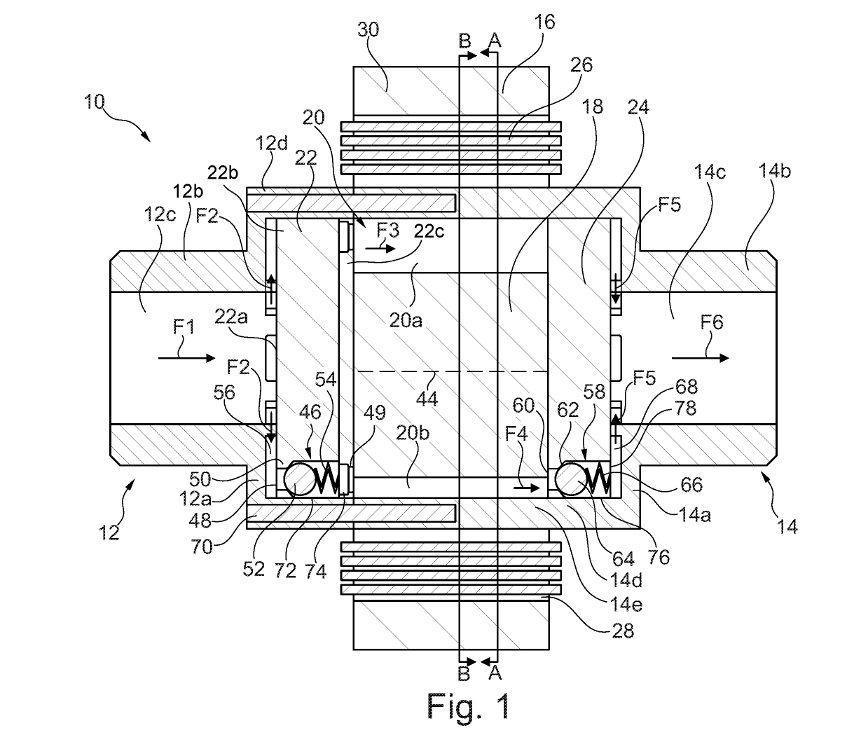

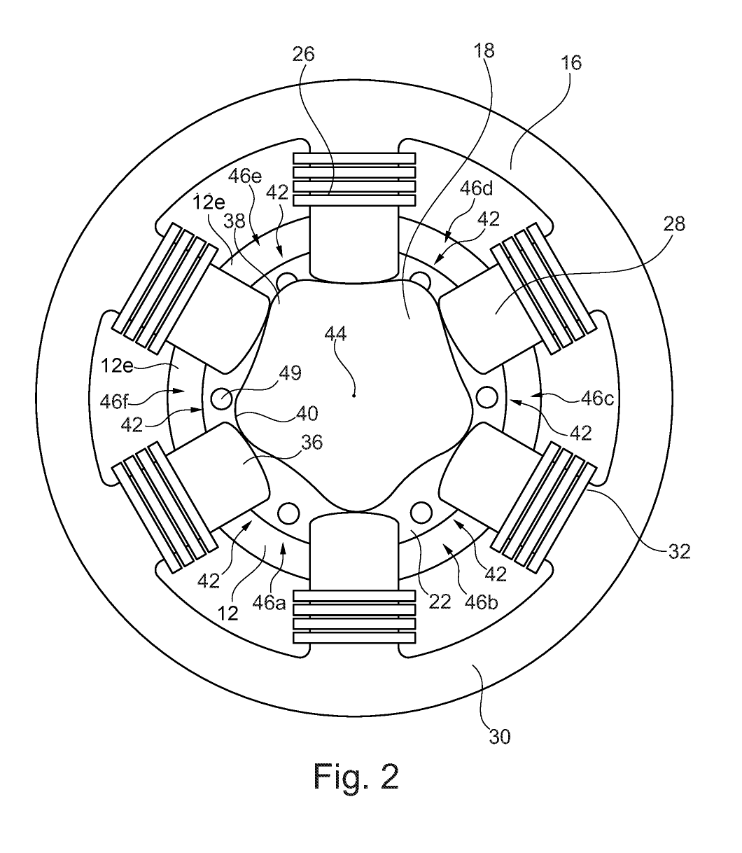

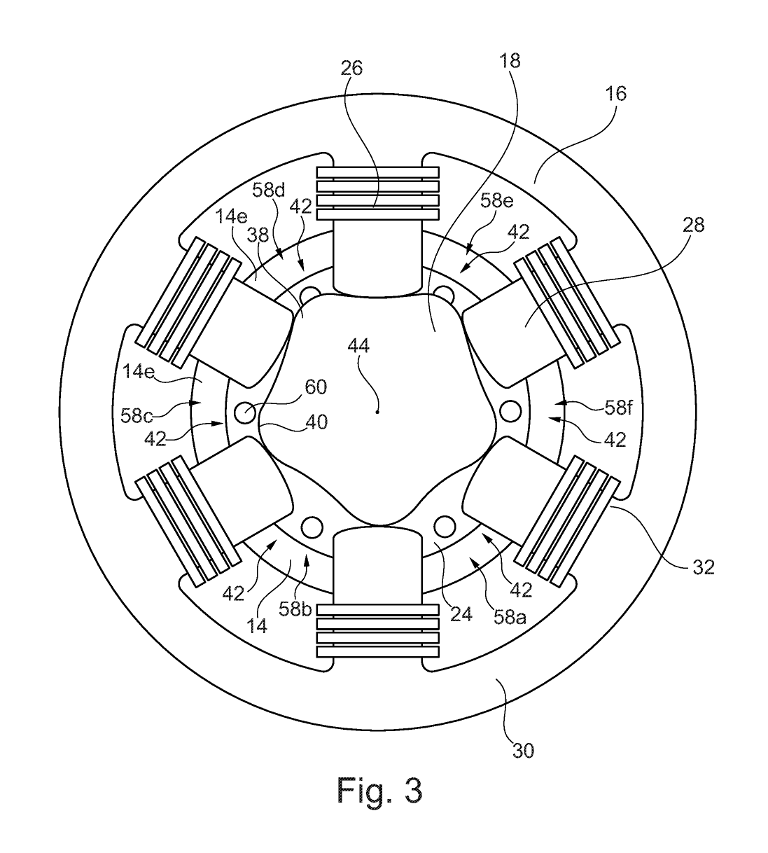

FIG. 1 schematically shows a cross-sectional side view of a pump 10 for an automotive vehicle transmission according to an embodiment of the present disclosure, FIG. 2 shows an axial cross-sectional view of pump 10 along A-A in FIG. 1 and FIG. 3 shows an axial cross-sectional view of pump 10 along B-B in FIG. 1. Pump 10 may be used in other contexts besides an automotive vehicle transmission, such as for example in marine, aerospace and industrial applications. Pump 10 includes a fluid inlet section 12 of the housing, a fluid outlet section 14 of the housing, a stator 16 axially between fluid inlet section 12 and fluid outlet section 14 and a rotor 18 axially between fluid inlet section 12 and the fluid outlet section 14. Rotor 18 and stator 16 define a fluid flow chamber 20 radially therebetween. Pump 10 also includes an inlet control section 22 configured for regulating fluid flow from fluid inlet section 12 into fluid flow chamber 20 and an outlet control section 24 configured for regulating fluid flow from fluid flow chamber 20 into fluid outlet section 14. Inlet control section 22 and outlet control section 24 are rotationally fixed so as not to rotate as rotor 18 rotates.

Stator 16 is provided with a plurality of electrical windings 26 for generating electromagnetic forces in stator 16 to urge rotor 18 toward stator 16 such that rotor 18 rotates inside of stator 16. In this embodiment, stator 16 is provided with six electrical windings 26, but in other embodiments, stator 16 may be provided with any other amounts of windings 26 greater than three. Windings 26 are each wrapped around one of legs 28 of stator 16. Stator 16 includes a cylindrical ring 30 defining an outer circumference of stator 16, with each leg 28 protruding radially inward from cylindrical ring 30. Legs 28 each include a base 32 extending radially inward from an inner circumference of cylindrical ring 30. Windings 26 are wrapped around base 32. Radially inside of windings 26, legs 28 each include a rounded radially innermost tip 36 protruding radially inward from base 32. Insulation layers may be provided over windings 26 to insulate windings from fluid flow chamber 20.

As shown in FIGS. 2 and 3, rotor 18 in this embodiment is substantially star shaped and includes a plurality of radially outwardly extending protrusions 38. In this embodiment, rotor 18 includes five protrusions 38, but in other embodiments rotor 18 may include other amounts of protrusions 38, with the amount of protrusions 38 being one less than the number of windings 26. Protrusions 38 each include a radially outermost rounded tip 40. Rotor 18 is configured such that during rotation thereof, protrusions 38 sequentially enter into slots 42 between tips 40 to continuously vary the configuration of fluid flow chamber 20. When an electric current is sent through any one of windings 26 a magnetic field is created which pulls rotor 18 toward that winding 26 in order to complete a magnetic circuit formed by the legs 28 of the stator. Rotor 18 moves toward the winding 26, rotor 18 displaces fluid, with which fluid flow chamber 20 between the rotor and stator is filled, creating pressure. The movement of rotor 18 within stator 16 separates fluid flow chamber 20 into a first portion 20a that is pressurized to force fluid out of outlet section 14 and a second portion 20b that forms a vacuum to draw fluid into fluid flow chamber 20 from inlet section 12. First portion 20a accordingly has a lower pressure than second portion 20b. As rotor 18 rotates within stator 16, the locations of first portion 20a and second portion 20b rotate about a center axis 44 of rotor, with first portion 20a being oriented on the opposite radial side of rotor 18 as second portion 20b during the rotation.

Inlet control section 22 is configured such that fluid from fluid inlet section 12 is forced through inlet control section 22 to fluid flow chamber 20 as first pressure portion 20a rotates about the center axis 44 of rotor 18. Outlet control section 24 is configured such that fluid from fluid flow chamber 20 is forced through outlet control section 24 from second pressure portion 20b to fluid outlet section 14 as second pressure portion 20b rotates about center axis 44 of rotor 18.

In order to regulate the flow of fluid from inlet section 12 into fluid flow chamber 20, inlet control section 22 includes a plurality of circumferentially spaced inlet control valves 46. In the embodiment shown in FIGS. 1 and 2, as shown in FIG. 2 by outlets 49 of inlet control valves 46, inlet control section 22 is provided with an inlet control valve 46 feeding into in each space 42, such that inlet control section 22 is provided with six inlet control valves 46. Each inlet control valve 46 is thus aligned between two legs 28, as viewed axially as in FIG. 2. In the embodiment shown in FIGS. 1 and 2, inlet control valves 46 are formed as check valves. Each inlet control valve 46 includes a seat 50 that surrounds an inlet 48, a closing member in the form of a ball 52, and a spring 54 forcing ball 52 against seat 50. An axial fluid flow F1 flows into inlet section 12 and is forced radially outward at a radially extending inlet facing surface 22a of inlet control section 22 to provide a radial fluid flow F2 to a channel 56 formed between a flanged portion 12a of inlet section 12 and surface 22a. The radial fluid flow F2 then meets inlet 48 and is regulated by ball 52 of inlet control valve 46.

Inlet control valves 46 are configured such that as first pressure portion 20a passes each of inlet control valves 46, the respective inlet control valve 46 being passed by the first pressure portion 20a opens, and such that as second pressure portion 20b passes each of inlet control valves 46, the respective inlet control valve 46 being passed by second pressure portion 20b closes. More specifically, ball 52 is forced against seat 50 via spring 54 when a force generated by spring 54 and a force generated by the fluid in chamber 20 on ball 52 exceeds a force generated on ball 52 via the fluid at inlet 48. When second portion 20b of fluid chamber 20 is aligned with an inlet control valve 46, ball 52 is held against seat 50 and fluid does not flow through the inlet control valve 46, as the force generated by spring 54 and the force generated by the fluid in chamber 20 on ball 52 exceeds the force generated on ball 52 via the fluid at inlet 48. When first portion 20a of fluid chamber 20 is aligned with an inlet control valve 46, ball 52 is forced away from seat 50, as the force generated on ball 52 via the fluid at inlet 48 exceeds the force generated by spring 54 and the force generated by the fluid in chamber 20 on ball 52 and an axial fluid flow F3 is generated in first portion 20a of fluid chamber 20 from the aligned inlet control valve 46. As first portion 20a is continuously rotating around axis 44, inlet control valves 46 are opened in succession when each inlet control valve 46 is aligned with first portion 20a. Also, as second portion 20b is continuously rotating around axis 44, adjacent inlet control valves 46 are closed in succession when each inlet control valve 46 is aligned with second portion 20b.

Referring to FIG. 2. and assuming that rotor 18 is rotating clockwise, check valves 46 at locations 46a, 46b are open because rotor protrusions 38 are not positioned in their adjacent spaces 42, check valves 46 at locations 46d, 46e are closed because rotor protrusions 38 are positioned in their adjacent spaces 42, check valve 46 at location 46f is closing as a rotor protrusion 38 is entering into its adjacent space 42 and check valve 46 at location 46c is opening as a rotor protrusion 38 is leaving its adjacent space 42.

In order to regulate the flow of fluid from fluid chamber 20 into fluid outlet section 14, outlet control section 24 includes a plurality of circumferentially spaced outlet control valves 58. In the embodiment shown in FIGS. 1 and 3, as shown in FIG. 3 by inlets 60 of outlet control valves 58, outlet control section 24 is provided with an outlet control valve 58 whose inlet 60 is fed by each space 42, such that outlet control section 24 is provided with six outlet control valves 58. Each outlet control valve 58 is thus aligned between two legs 28, as viewed axially from outlet section 14. In the embodiment shown in FIG. 1, outlet control valves 58 are formed as check valves. Each outlet control valve 58 includes a seat 62 that surrounds inlet 60, a closing member in the form of a ball 64, and a spring 66 forcing ball 64 against seat 62.

Outlet control valves 58 are configured such that as second pressure portion 20b passes each of the outlet control valves 58, the respective outlet control valve 58 being passed by second pressure portion 20b opens, and such that as first pressure portion 20a passes each of outlet control valves 58, the respective outlet control valve 58 being passed by first pressure portion 20a closes. More specifically, ball 64 is forced against seat 62 via spring 66 when a force generated by spring 66 and a force generated by fluid downstream of ball 64 (if any) exceeds a force generated on ball 64 via the fluid at inlet 60. When first portion 20a of fluid chamber 20 is aligned with an outlet control valve 58, ball 64 is held against seat 62 and fluid does not flow through the outlet control valve 58, as the force generated by spring 66 and the force generated by the fluid downstream of ball 64 exceeds the force generated on ball 64 via the fluid at inlet 60. When second portion 20b of fluid chamber 20 is aligned with an outlet control valve 58, ball 64 is forced away from seat 62, as the force generated on ball 64 via the fluid at inlet 60 exceeds the force generated by spring 66 and the force generated by the fluid downstream of ball 64 and an axial fluid flow F4 is generated in second portion 20b of fluid chamber 20 that flows through outlet control valve 58. The fluid flowing through the outlet control valve 58 then flows radially inward to generate a radial fluid flow F5 through a channel 68 formed between a flanged portion 14a of outlet section 14 and radially extending outlet facing surface 24a of outlet control section 24. Radial fluid flow F5 then merges into an axial fluid flow F6 flowing out of outlet section 14. As second portion 20b is continuously rotating around axis 44, adjacent outlet control valves 58 are opened in succession when each outlet control valve 58 is aligned with second portion 20b. Also, as first portion 20a is continuously rotating around axis 44, adjacent outlet control valves 58 are closed in succession when each outlet control valve 46 is aligned with second portion 20b.

Referring to FIG. 3. and assuming that rotor 18 is rotating counterclockwise, check valves 58 at locations 58a, 58b are closed because rotor protrusions 38 are not positioned in their adjacent spaces 42, check valves 58 at locations 58d, 58e are open because rotor protrusions 38 are positioned in their adjacent spaces 42, check valve 58 at location 58f is opening as a rotor protrusion 38 is entering into its adjacent space 42 and check valve 58 at location 58c is closing as a rotor protrusion 38 is leaving its adjacent space 42. Accordingly, rotor 18 and stator 16 are configured such that each of first pressure portion 20a and second pressure portion 20b passes by each of inlet control valves 46 and each of outlet control valves 58 multiple times during a single rotation of rotor 18 about center axis 44. More specifically, in the embodiment shown in FIGS. 1 to 3, each check valve 48, 58 is closed and opened during each ⅕ rotation of rotor 18 about axis 44, such that each check valve 46, 58 is closed and opened an amount of time equal to the number of protrusions 38 during each rotation of rotor 18 about axis 44.

Each of inlet section 12 and outlet section 14 has a stepped cylindrical shape. Inlet section 12 includes a smaller cylindrical section 12b that defines an upstream chamber 12c for axial fluid flow F1 and a larger cylindrical section 12d downstream of section 12b that is radially outside of and circumferentially surrounds inlet control section 22. Smaller and larger cylindrical sections 12b, 12d are joined by flange section 12a, which is disc-shaped. Outlet section 14 includes a smaller cylindrical section 14b that defines a downstream chamber 14c for axial fluid flow F6 and a larger cylindrical section 14d upstream of section 12b that is radially outside of and circumferentially surrounds outlet control section 24. Smaller and larger cylindrical sections 14b, 14d are joined by flange section 14a, which is disc-shaped. Outlet section 14 further includes a plurality of circumferentially spaced axially extending fingers 14e protruding axially from section 14d toward inlet section 12. As shown in FIGS. 2 and 3, each of fingers 14e is positioned between two legs 28 of stator 16. Inlet section 12 and out section 14 are fixed together by fasteners 70 extending axially through section 12d into fingers 14e.

In the embodiment shown in FIGS. 1 and 2, inlet control section 22 is formed as a circular plate having two plate sections 22b, 22c that are joined together. The first plate section 22b includes a plurality of bores machined therein that form inlets 48 of inlet control valves 46 and a central chamber 72, which is enlarged with respect to inlet 48, for receiving ball 52 and spring 54. The second plate section 22c includes a stepped bore 74 that receives an end of spring 54, with the step of the bore providing a surface of axially abutting the end of spring 54. In the embodiment shown in FIGS. 1 and 3, outlet control section 24 is formed as a circular plate having a single plate section. The plate section defining outlet control section 24 includes a plurality of bores machined therein that form inlets 60, a central chamber 76 and outlets 78 of outlet control valves 58. Central chamber 76 is enlarged with respect to inlet 60 and receives ball 64 and spring 66. One end of spring 66 abuts ball 64 and the other end of spring 66 extends into channel 68 and abuts flange section 14a.

A method of constructing pump 10 can include inserting inlet control section 22 into larger cylindrical section 12d of fluid inlet 12 and inserting inlet control section 24 into larger cylindrical section 14d of fluid outlet 14. Axially extending fingers 14e of fluid outlet 14 are then inserted into gaps between legs 28 of stator 16 and rotor 18 is positioned radially inside of axially extending fingers 14e and legs 28. Next, inlet section 12, with inlet control section 14 provided therein, is pressed axially against axial ends of axially extending fingers 14e and axial ends of legs 28, and fasteners 70 are passing axially through larger cylindrical section 12d of fluid inlet 12 and into axially extending fingers 14e to fix all of the components together. It should be noted that instead of outlet section 14 being provided with fingers 14e, inlet section 12 can be provided with fingers or both of inlet section 12 and outlet section 14 can be provided with fingers that are axially shorter than fingers 14e such that axial ends of the shorter fingers can axially abut each other between legs 28.

Pump 10 also includes a controller configured to control the flow of the current through electrical windings 26 to rotate the rotor. In this embodiment, controller is in the form of transistors on control board for electrically commutating and controlling pump 10. Alternately, the controller can be remote and connected to windings 26 by wires.

In the embodiment shown in FIGS. 1 to 3, pump 10 is a gerotor pump; however, in other embodiments, a similar construction may be made with other pump types, including an internal gear pump or a vane pump.

In the preceding specification, the disclosure has been described with reference to specific exemplary embodiments and examples thereof. It will, however, be evident that various modifications and changes may be made thereto without departing from the broader spirit and scope of disclosure as set forth in the claims that follow. The specification and drawings are accordingly to be regarded in an illustrative manner rather than a restrictive sense.

### LIST OF REFERENCE NUMERALS

10 pump
12 fluid inlet section
12a flanged portion
12b smaller cylindrical section
12c upstream chamber
12d larger cylindrical section
14 fluid outlet section
14a flanged portion
14b smaller cylindrical section
14c downstream chamber
14d larger cylindrical section
14e axially extending fingers
16 stator
18 rotor
20 fluid flow chamber
20a first pressure portion
20b second pressure portion
22 inlet control section
22a radially extending inlet facing surface
22b first plate section
22c second plate section
24 outlet control section
26 electrical windings
28 stator legs
30 cylindrical ring
32 base
36 rounded radially innermost tip
38 radially outwardly extending protrusions
40 radially outermost rounded tip
42 slots
44 rotor center axis
46 inlet check valves
46a, 46b, 46c, 46d, 46e, 46f inlet check valve locations
48 inlet
49 outlet
50 seat
52 ball
54 spring
56 channel
58 outlet check valve
58a, 58b, 58c, 58d, 58e, 58f outlet check valve locations
60 inlet
62 seat
64 ball
66 spring
68 channel
70 fasteners
72 central chamber
74 stepped bore
76 central chamber
78 outlet
F1 inlet axial fluid flow
F2 inlet radial fluid flow
F3 chamber entering axial fluid flow
F4 chamber exiting axial fluid flow
F5 outlet radial fluid flow
F6 outlet axial fluid flow

What is claimed is:

1. A pump comprising:
a fluid inlet section;
a fluid outlet section;
a stator axially between the fluid inlet section and the fluid outlet section;
a rotor axially between the fluid inlet section and the fluid outlet section, the rotor and the stator defining a fluid flow chamber radially therebetween, the rotor being rotatable inside of the stator by electromagnetic forces urging the rotor towards the stator;
an inlet control section configured for regulating fluid flow from the fluid inlet section into the fluid flow chamber; and
an outlet control section configured for regulating fluid flow from the fluid flow chamber into the fluid outlet section,
the rotor, the stator, the inlet control section and the outlet control section being arranged and configured such that rotation of the rotor in the stator generates in the fluid flow chamber a first pressure portion and a second pressure portion that rotate about a center axis of the rotor, the first pressure portion having a lower pressure than the second pressure portion, the inlet control section being configured such that fluid from the fluid inlet section is forced through the inlet control section to the first pressure portion as the first pressure portion rotates about the center axis of the rotor, the outlet control section being configured such that fluid from the fluid flow chamber is forced through the outlet control section from the second pressure portion to the fluid outlet section as the second pressure portion rotates about the center axis of the rotor.

2. The pump as recited in claim 1 wherein the inlet control section includes a plurality of circumferentially spaced inlet control valves and the outlet control section includes a plurality of circumferentially spaced outlet control valves.

3. The pump as recited in claim 2 wherein the rotor and stator are configured such that each of the first pressure portion and the second pressure portion passes by each of the inlet control valves and each of the outlet control valves multiple times during a single rotation of the rotor about the center axis of the rotor.

4. The pump as recited in claim 3 wherein the inlet control valves are configured such that as the first pressure portion passes each of the inlet control valves, the respective inlet control valve being passed by the first pressure portion opens.

5. The pump as recited in claim 4 wherein the inlet control valves are configured such that as the second pressure portion passes each of the inlet control valves, the respective inlet control valve being passed by the second pressure portion closes.

6. The pump as recited in claim 3 wherein the outlet control valves are configured such that as the second pressure portion passes each of the outlet control valves, the respective outlet control valve being passed by the second pressure portion opens.

7. The pump as recited in claim 6 wherein the outlet control valves are configured such that as the first pressure portion passes each of the outlet control valves, the respective outlet control valve being passed by the first pressure portion closes.

8. The pump as recited in claim 2 wherein each of the inlet control valves and each of the outlet control valves is check valve including a seat, a closing member and a spring.

9. The pump as recited in claim 1 wherein the inlet control section and the outlet control section are rotationally fixed so as not to rotate as the rotor rotates.

10. The pump as recited in claim 1 wherein the rotor and the stator are arranged and configured such that the rotor moves eccentrically within the stator.

11. The pump as recited in claim 1 wherein the stator includes at least four electrical windings configured for receiving current to generate the electromagnetic forces for urging the rotor towards the stator to rotate the rotor.

12. An automotive vehicle transmission comprising the pump recited in claim 1.

13. A method of constructing a pump comprising:
providing a rotor radially inside of a stator;
fixing an inlet control section with respect to the stator at a first axial side of the rotor;
fixing an outlet control section with respect to the stator at a second axial side of the rotor;
providing a fluid inlet section upstream of the inlet control section; and
providing a fluid outlet section downstream of the outlet control section, the rotor and the stator defining a fluid flow chamber radially therebetween,
the rotor, the stator, the inlet control section and the outlet control section being arranged and configured such that rotation of the rotor in the stator generates in the fluid flow chamber a first pressure portion and a second pressure portion that rotate about a center axis of the rotor, the first pressure portion having a lower pressure than the second pressure portion, the inlet control section being configured such that fluid from the fluid inlet section is forced through the inlet control section to the first pressure portion as the first pressure portion rotates about the center axis of the rotor, the outlet control section being configured such that fluid from the fluid flow chamber is forced through the outlet control section from the second pressure portion to the fluid outlet section as the second pressure portion rotates about the center axis of the rotor.

14. The method as recited in claim 13 wherein the inlet control section includes a plurality of circumferentially spaced inlet control valves and the outlet control section includes a plurality of circumferentially spaced outlet control valves.

15. The method as recited in claim 14 wherein the rotor and stator are configured such that each of the first pressure portion and the second pressure portion passes by each of the inlet control valves and each of the outlet control valves multiple times during a single rotation of the rotor about the center axis of the rotor.

16. The method as recited in claim 15 wherein the inlet control valves are configured such that as the first pressure portion passes each of the inlet control valves, the respective inlet control valve being passed by the first pressure portion opens,
the inlet control valves being configured such that as the second pressure portion passes each of the inlet control valves, the respective inlet control valve being passed by the second pressure portion closes,
the outlet control valves being configured such that as the second pressure portion passes each of the outlet control valves, the respective outlet control valve being passed by the second pressure portion opens,
the outlet control valves being configured such that as the first pressure portion passes each of the outlet control valves, the respective outlet control valve being passed by the first pressure portion closes.

17. The method as recited in claim 13 further comprising inserting the inlet control section into a section of the fluid inlet section and inserting the outlet control section into a section of the fluid outlet section.

18. The method as recited in claim 17 wherein the stator includes a plurality of windings and a plurality of legs, each of the windings being wrapped around one of the legs, at least one of the fluid inlet section and the fluid outlet section including a plurality of axially extending fingers, the axially extending fingers being slid in between the legs radially inside of the winding.

19. The method as recited in claim 18 wherein the rotor is positioned radially inside of the axially extending fingers.
